(19) United States
(12) Patent Application Publication
(10) Pub. No.: US 2006/0154163 A1
(43) Pub. Date: Jul. 13, 2006

(54) Toner for electrostatic image development

(75) Inventor: Hiroto Kidokoro, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, Tokyo (JP)

(21) Appl. No.: 10/549,144

(22) PCT Filed: Mar. 15, 2004
(86) PCT No.: PCT/JP04/03405

§ 371 Date: Sep. 15, 2005

(30) Foreign Application Priority Data
Mar. 17, 2003 (JP) 2003-071590
Jun. 30, 2003 (JP) 2003-187646

(51) Int. Cl. G03G 9/00; G03G 5/00

(52) U.S. Cl. 430/108.22; 430/108.3; 430/137.14; 430/108.8

(57) ABSTRACT

The toner for developing the electrostatic latent image of the present invention is composed of a toner particles containing at least a binder resin, a colorant, a charge control agent and a parting agent, the toner particles having a volume mode diameter (a) in the range from 5 to 10 μm, the ratio (Dv/Dp), of a volume average particle diameter (Dv) to a number average particle diameter (Dp), from 1.0 to 1.3, and an average circle degree in the range from 0.94 to 0.97, the toner particles having a standard deviation (b) not more than 2.5 μm of particle diameter, a ratio (C1/C2) from 1.01 to 1.03, wherein c1 represents an average circle degree of the toner particles having a particle diameter not less than (a−2b) μm to less than a μm, and c2 represents an average circle degree of the toner particles having a particle diameter not less than a μm and less than (a+2b) μm, and the toner for developing an electrostatic latent image having a content, of an isopropyl alcohol extract component, of 5% by weight or less. The toner for developing an electrostatic latent image of the present invention is excellent in shelf stability, difficult to cause fog and excellent in cleaning properties and charging stability.

### TECHNICAL FIELD

The present invention relates to a toner for developing an electrostatic latent image, and more specifically to a toner for developing an electrostatic latent image, excellent in properties such as shelf stability and cleaning properties.

### BACKGROUND ART

Electrophotography, in general, is a process involving forming an electrostatic latent image on a photoconductive member by various methods, followed by development of the latent image to a visible image, and after transferring toner forming the visible image to a transfer member such as paper or an OHP sheet, fixing the transferred toner on the transfer member by pressure or the like, thereby obtaining printing.

Currently, printers and copying machines are becoming more and more advanced and achievement of high speed as well as high resolution by a method of forming an electrostatic latent image by a laser is demanded. Accordingly, in addition to achieving small particle diameter and sharp particle diameter distribution for responding to the high resolution requirement, toners are required to have low-temperature fixability so as to correspond with high-speed model equipment. In addition, stability of electrostatic properties and cleaning properties of toners are required as in conventional cases.

Conventionally, toners have been produced by the pulverization method, namely, by melting and mixing colorant such as dye or pigment and other additives with binder resin such as thermoplastic resin and dispersing homogeneously, followed by fine pulverization by a pulverizer. In this pulverization method, it is difficult to make the particle diameter of toner about 5 to 6 μm or smaller, and there is a limit to narrowing of the particle diameter distribution by using the classification step. Further, because additives are exposed on the toner surface, control of the amount of electrostatic charge of toner is difficult, causing problems such as scattering of images and fog. As an example of toner produced by such pulverization method, Japanese Patent Application Laid-Open No. 1999-202557 discloses a toner with a controlled particle diameter, particle diameter distribution, circle degree, etc. The toner disclosed in the above publication is produced by a pulverization method, and it is difficult to remove fine particles or avoid generation of fine powder, and because of wide circle degree distribution, the toner had insufficient dot reproduction and the like.

To solve these problems, a spherical toner having a small particle diameter and a narrow particle diameter distribution are suitable, and for example, Japanese Patent Application Laid-Open No. 2000-3069 discloses a toner having a specific volume average particle diameter, average circle degree and standard deviation of circle degree. However, in this toner, which is produced by a pulverization method, highly polar components such as a colorant and charge control agent are exposed near the toner surface. Thus, the stability of electrostatic properties is insufficient when such toner is stored for a long time and in addition, cleaning properties are poor and filming easily occurs, requiring further improvement.

Japanese Patent Application Laid-Open No. 1999-344829 discloses a toner produced by suspension polymerization, which contains high polarity resin and a low molecular component and which has an average circle degree of 0.970 to 0.995. However, the toner disclosed in the publication tends to change in the amount of electrostatic charge in the case of long term storage, easily caused fog and the cleaning properties were insufficient.

Japanese Patent Application Laid-Open No. 2002-31913 discloses a process of producing a toner by suspension polymerization. This toner has stable electrostatic properties and causes little fog, but cleaning properties were insufficient.

Further, Japanese Patent Application Laid-Open No. 2003-29459 discloses a toner which is obtained by agglomerating a polymer obtained by emulsion polymerization and has an average circle degree of 0.94 to 0.98 and a gradient of the circle degree to the circle equivalent diameter of −0.005 to −0.001. This toner tends to change in the amount of electrostatic charge in the case of long term storage and easily caused fog.

Accordingly, the object of the present invention is to provide a toner for developing an electrostatic latent image, that is excellent in shelf stability, difficult to cause fog and excellent in cleaning properties and charging stability.

### DISCLOSURE OF THE INVENTION

The inventor of the present invention carried out an in-depth study to accomplish the object. As a result, he has found that this object can be accomplished by; using a toner for developing an electrostatic latent image, comprising a toner particles containing at least a binder resin, a colorant, a charge control agent and a parting agent; controlling the volume mode diameter, the ratio (Dv/Dp) of the volume average particle diameter (Dv) and the number average particle diameter (Dp), circle degree, the standard deviation (b) of particle diameter, the ratio (C1/C2) of an average circle degree (C1) of toner particles having a specific size to the average circle degree (C2) of toner particles having a specific size, and further controlling the isopropyl alcohol extract component into a specific range.

The present invention has been accomplished based on the above finding. According to the present invention, there is provided a toner for developing an electrostatic latent image, comprising a toner particles containing at least a binder resin, a colorant, a charge control agent and a parting agent, the toner particles having a volume mode diameter (a) in the range from 5 to 10 μm, the ratio (Dv/Dp), of a volume average particle diameter (Dv) to a number average particle diameter (Dp), from 1.0 to 1.3, and an average circle degree in the range from 0.94 to 0.97, the toner particles having a standard deviation (b) not more than 2.5 μm of particle diameter, a ratio (C1/C2) from 1.01 to 1.03, wherein c1 represents an average circle degree of the toner particles having a particle diameter not less than (a−2b) μm to less than a μm, and c2 represents an average circle degree of the toner particles having a particle diameter not less than a μm and less than (a+2b) μm, and the toner for developing an electrostatic latent image having a content, of an isopropyl alcohol extract component, of 5% by weight or less.

The above described toner for developing an electrostatic latent image is excellent in shelf stability, difficult to cause fog and excellent in cleaning properties and charge stability.

The above described toner for developing an electrostatic latent image preferably has an acid value of 5 mg KOH/g or less, and an amine value of 3.25 mg HCl/g or less.

The above described parting agent preferably has a weight average molecular weight in the range from 1,000 to 3,000 or a melting point in the range from 40 to 100° C.

The above described parting agent is preferably a synthetic wax or a multifunctional ester compound.

The above described charge control agent is preferably a charge control resin having a weight average molecular weight in the range from 3,000 to 300,000.

In the above described toner for developing an electrostatic latent image, the isopropyl alcohol extract component preferably has a hydroxyl value of 25 mg KOH/g or less.

The present invention provides a process for producing a toner for developing an electrostatic latent image, which comprises: adding a polymerizable monomer composition containing a polymerizable monomer, a colorant, a charge control agent, a parting agent and a polymerization initiator to an aqueous dispersion medium containing an inorganic compound as a dispersion stabilizer, thereby preparing an aqueous dispersion containing droplets of the polymerizable monomer composition, and adding 0.01 to 0.5 part by weight of an anionic surfactant per 100 parts by weight of the polymerizable monomer to the aqueous dispersion, subjected to initialize a polymerization reaction.

The above described parting agent preferably has a weight average molecular weight in the range from 1,000 to 3,000 or a melting point in the range from 40 to 100° C.

The above described parting agent is preferably a synthetic wax or a multifunctional ester compound.

The above described charge control agent is preferably a charge control resin having a weight average molecular weight in the range from 3,000 to 300,000.

The above described inorganic compound is preferably a colloid of a hardly water-soluble inorganic compound.

The above described colloid of a hardly water-soluble inorganic compound preferably has a 50% cumulative value of the number particle diameter distribution of 0.5 μm or less.

The amount of the above-mentioned inorganic compound is preferably 0.01 to 20 parts by weight based on 100 parts by weight of the polymerizable monomer.

### BEST MODE FOR CARRYING OUT THE INVENTION

A toner for developing an electrostatic latent image according to the present invention is described in detail below.

The toner particles comprising the toner for developing an electrostatic latent image of the present invention comprises at least a binder resin, a colorant agent, a charge control agent and a parting agent.

As the binder resin, there can be mentioned; resins such as polystyrene, styrene-butyl acrylate copolymers, polyester resins and epoxy resins, which are conventionally commonly used for the toner.

As the colorant, there can be mentioned; any pigments and dyes, including carbon black, titanium black, magnetic powder, oil black, and titanium white. Carbon black having a primary particle diameter in the range from 20 to 40 nm is preferably used as a black colorant. The particle diameter within this range is preferred, because such carbon black can be uniformly dispersed in the toner and fog in printed image developed using the resulting toner decreases.

For a full color toner, a yellow colorant, a magenta colorant and a cyan colorant are generally used.

As the yellow colorant, there can be mentioned; compounds such as azo pigments, and condensed polycyclic pigments. Specific examples of the yellow colorant include pigments such as C. I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C.I. Pigment Blue 2, 3, 6, 15, 15:1, 15:2, 15:3, 15:4, 16, 17, and 60.

Any of these colorants is used, preferably, in the amount of 1 to 10 parts by weight per 100 parts by weight of the binder resin.

For forming full color images, toners respectively containing a colorant of three colors of cyan, magenta, yellow and where necessary, black are combined, and development is carried out.

As a charge control agent, a charge control resin is preferable, because charge control resins have high compatibility with binder resins, are colorless, and can provide a toner with a stable charging property even when it is used in high-speed continuous color printing. As the charge control resin, there can be mentioned; quaternary ammonium (salt) group-containing copolymers produced in accordance with the descriptions of Japanese Patent Application Laid-Open Nos. 1988-60458, 1991-175456, 1991-243954, and 1999-15192, and sulfonic acid (salt) group-containing copolymers produced in accordance with the descriptions of Japanese Patent Application Laid-Open Nos. 1989-217464 and 1991-15858.

The amount of the monomer unit having the quaternary ammonium (salt) group or the sulfonic acid (salt) group contained in these copolymers is preferably 0.5 to 15% by weight, more preferably 1 to 10% by weight. If the content of the monomer unit is within this range, the charge level of the toner is easy to control, and the generation of fog in printed image developed using the toner can be minimized.

Preferred as the charge control resin is that having a weight average molecular weight of 3,000 to 300,000, more preferably 4,000 to 50,000, most preferably 6,000 to 35,000.

The glass transition temperature of the charge control resin is preferably 40 to 80° C., more preferably 45 to 75° C., most preferably 45 to 70° C. If the glass transition temperature of the charge control resin is lower than 40° C., the shelf stability of the resulting toner may become deteriorated. If the glass transition temperature exceeds 80° C., fixability of the resulting toner may lower. The glass transition temperature is measured by a differential scanning calorimeter.

The amount of the charge control agent used is generally 0.01 to 30 parts by weight, preferably 0.3 to 25 parts by weight, per 100 parts by weight of the binder resin.

As the parting agent, there can be mentioned; polyolefin waxes such as low molecular weight polyethylene, low molecular weight polypropylene, and low molecular weight polybutylene; natural plant waxes such as candelilla, carnauba, rice, wood wax, and jojoba; petroleum waxes such as paraffin, microcrystalline and petrolatum, as well as waxes modified therefrom; synthetic waxes such as Fischer-Tropsch wax; and polyfunctional ester compounds such as pentaerythritol tetramyristate, pentaerythritol tetrapalmitate, and dipentaerythritol hexamyristate. These parting agents may be used alone or in a combination thereof.

Among these parting agents, synthetic waxes and multifunctional ester compounds are preferred. multifunctional ester compounds are more preferred, which show an endothermic peak temperature within a range of, preferably 30° C. to 150° C., more preferably 40° C. to 100° C., and most preferably 50° C. to 80° C., measured with a DSC curve by means of a differential scanning calorimeter (DSC) at rising temperature, because a toner excellent in a balance between fixing-peeling property during fixing is obtained. In particular, those having a weigh average molecular weight of 1,000 to 3,000 are preferred, and those having a weight average molecular weight of 1,500 to 2,000 are more preferred. In this regard, the weight average molecular weight is measured by gel permeation chromatography using tetrahydrofuran converted to polystyrene. In addition, those soluble in styrene at 25° C. in the proportion of 5 parts by weight or more based on 100 parts by weight of styrene, and has an acid value of 10 mg KOH/g or less, is even more preferred, because it exhibits a distinguished effect in lowering the fixing temperature. The above-mentioned endothermic peak temperatures refer to values measured in accordance with ASTM D3418-82. In addition, the parting agents having a melting point of 40 to 100° C. are preferred, and parting agents having a melting point of 40 to 70° C. are more preferred.

The amount of the parting agent is generally 0.5 to 50 parts by weight, preferably 1 to 20 parts by weight, per 100 parts by weight of the binder resin.

The toner particle may be a so-called core-shell structure (also called “capsule type”) particle, in which the binder resin for an inner layer of the particle (core layer) is different from the binder resin for an outer layer of the particle (shell layer). The core-shell structure is preferred, because the structure can provide a favorable balance between lowering of the fixing temperature and prevention of aggregation of the toner during storage by covering the low softening point substance as the inner layer (core layer) with a substance having a higher softening point (shell layer).

Generally, the core layer of the core-shell structure particle is composed of the aforementioned binder resin, colorant, charge control resin, and parting agent, while the shell layer is composed of the binder resin alone.

The proportion by weight of the core layer to the shell layer of the core-shell structure particle is not particularly limited, but is generally in the range (core layer/shell layer) of from 80/20 to 99.9/0.1. By using the shell layer in this proportion, good shelf stability and good low temperature fixability of the toner for developing an electrostatic latent image can be fulfilled at the same time.

The average thickness of the shell layer of the core-shell structure particle may be generally 0.001 to 1.0 μm, preferably 0.003 to 0.5 μm, and more preferably 0.005 to 0.2 μm. If the thickness is too large, fixability of the resulting toner may decline. If it is too small, shelf stability of the resulting toner may decline. The core particle constituting the core-shell structure toner particle does not necessarily have all of its surface covered with the shell layer. The surface of the core particle may partly be covered with the shell layer.

The diameter of the core particle and the thickness of the shell layer of the core-shell structure particle can be measured by directly measuring the size and shell thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner for developing an electrostatic latent image.

The toner for developing an electrostatic latent image of the present invention comprises the toner particles having a volume mode diameter (a) of 5 to 10 μm, preferably 5 to 8 μm. If the volume mode diameter(a) is less than 5 μm, flowability of the toner decreases. As a result, fog may be generated in printed image, the toner may partly remain untransferred, or cleaning properties may deteriorate. If the volume mode diameter exceeds 10 μm, reproducibility of fine lines may decline. The volume mode diameter (a) means the mode in particle diameter distributions based on volume. The volume mode diameter of toner particles may be measured, for example, with flow type particle projection image analyzers such as FPIA-1000 or FPIA-2000, products of Sysmex Corporation.

The toner particles constituting the toner for developing an electrostatic latent image of the present invention has a ratio (Dv/Dp) of a volume average particle diameter (Dv) to the number average particle diameter (Dp) of 1.0 to 1.3, preferably 1.0 to 1.2. If Dv/Dp exceeds 1.3, fog occur in printed image.

The volume average particle diameter and the number average particle diameter of the toner particles can be measured, for example, by use of Multisizer (manufactured by Beckman Coulter, Inc.)

The toner particles constituting the toner for developing an electrostatic latent image according to the present invention have average circle degree of 0.94 to 0.97, preferably 0.94 to 0.965, more preferably 0.945 to 0.965 as measured by a flow particle image analyzer. If the average circle degree is less than 0.94, reproducibility of fine lines is poor in any of an L/L environment (temperature: 10° C., humidity: 20%), an N/N environment (temperature: 23° C., humidity: 50%) or an H/H environment (temperature: 35° C., humidity: 80%).

The average circle degree can be controlled into these range relatively easily by producing the toner by phase-transfer emulsion process, solution suspension process, or polymerization process (suspension polymerization process, emulsion polymerization process), etc.

In the present invention, the circle degree of a particle is defined as a circuit length of the circle which has the same area with the projection of the particle, divided by perimeter length of the projection of the particle. The average circle degree is adopted to represent shapes of the particle quantitatively and simply, and it is an index which shows a degree of the roughness of the particles. If the toner particles are perfectly spherical, the average circle degree equals to 1. The more complicated the surface of the particles are, the smaller the average circle degree becomes. The average circle degree (Ca) is calculated using the second next following formula.

$$Average circularity = ( {\sum }_{i = 1}^{n} ( Ci \times fi ) ) / {\sum }_{i = 1}^{n} ( fi )$$

In the above formula, n represents the number of particles used for calculating the circle degree Ci.

In the above formula, Ci represents the circle degree of each particle in a group of particles having a circle equivalent diameter of 0.6 to 400 μm, which is calculated by the following formula from the measured circuit length of each particle.

Circle degree (Ci)=circuit length of the circle having the same area with the projection of each particle/perimeter length of the projection of each particle

In the above formula, fᵢ denotes frequency of particle having circle degree Cᵢ. The Circle degree and the average circle degree may be measured with flow type particle projection image analyzers, such as FPIA-1000 or FPIA-2000, products of Sysmex Corporation.

The standard deviation (b) of the particle diameter of the toner particles constituting the toner for developing an electrostatic latent image according to the present invention is 2.5 μm or less, preferably, 2 μm or less. If the standard deviation of the particle diameter of the toner particles exceeds 2.5 μm, the amount of electrostatic charge becomes unstable and fog tends to occur. The standard deviation of the particle diameter of the toner particles is calculated from distribution based on volume, which is a value on a volume basis that may be measured with flow type particle projection image analyzers, such as FPIA-1000 or FPIA-2000 products of Sysmex Corporation as in the case of measuring circle degree and average circle degree.

The toner particles constituting the toner for developing an electrostatic latent image according to the present invention has a (C1/C2) of 1.01 to 1.03, preferably, 1.02 to 1.03, when the volume mode diameter is defined as “a” and the standard deviation of particle diameter of toner particles is defined as “b”, and the average circle degree of toner particles having a particle diameter of not less than (a−2b) μm to less than a μm is defined as C1 and the average circle degree of toner particles having a particle diameter of not less than a μm to less than (a+2b) μm is defined as C2. This value indicates a coalescent state of toner particles. A greater C1/C2 indicates that the number of so-called coalescent particles in which two toner particles are fused is great. When (C1/C2) is within the above-mentioned range, it is easier to obtain a toner excellent in shelf stability, causing little fog and excellent even in cleaning properties and charging stability.

The above-mentioned C1 and C2 can also be measured with flow type particle projection image analyzers, such as FPIA-1000 or FPIA-2000 products of Sysmex Corporation as in the case of measuring circle degree and average circle degree.

The toner particles constituting the toner for developing an electrostatic latent image according to the present invention preferably has a content of an isopropyl alcohol extract component of 5% by weight or less, more preferably 4% by weight or less. If the content of the isopropyl alcohol extract component exceeds 5% by weight, environmental stability (reproducibility of fine lines) tends to decrease and fog may occur. The content of the isopropyl alcohol extract component can be measured according to the method described later.

The toner for developing an electrostatic latent image according to the present invention preferably has an acid value of 5 mg KOH/g or less, more preferably3 mg KOH/g or less. If the acid value of the toner for developing an electrostatic latent image exceeds 5 mg KOH/g, fog may occur.

The toner for developing an electrostatic latent image according to the present invention preferably has an amine value of 3.25 mg HCl/g or less, more preferably 3 mg HCl/g or less. If the amine value of the toner for developing an electrostatic latent image exceeds 3.25 mg HCl/g, fog may occur.

The acid value and the amine value of the toner for developing an electrostatic latent image can be measured according to the method described later.

In the toner for developing an electrostatic latent image according to the present invention, the hydroxyl value of the isopropanol extract component is preferably 25 mg KOH/g or less, more preferably 20 mg KOH/g or less. If the hydroxyl value of the isopropyl alcohol extract component exceeds 25 mg KOH, the charging stability may be decreased and fog may occur upon development under high temperature high humidity conditions.

The hydroxyl value of the isopropyl alcohol extract component of the toner for developing an electrostatic latent image can be measured according to the method described later.

The toner for developing the electrostatic image according to the present invention can be used, as it is, for development in electrophotography. Generally, however, it is preferrable that the toner is used after fine particles having a smaller particle diameter than that of the toner particles (the fine particles will be referred to hereinafter as an external additive) are adhered to or buried into the surfaces of the toner particles, in order to adjust the charging properties, flowability and shelf stability of the toner.

Examples of the external additive are inorganic particles and organic resin particles which are generally used for improving flowability and charging properties. These particles, added as the external additives, have a smaller average particle diameter than that of the toner particles. Specific examples of the inorganic particles include silica, aluminum oxide, titanium oxide, zinc oxide, and tin oxide. Specific examples of the organic resin particles include methacrylic ester polymer particles, acrylic ester polymer particles, styrene-methacrylic ester copolymer particles, styrene-acrylic ester copolymer particles, core-shell structure particles having a core formed of a styrene polymer and a shell formed of a methacrylic ester polymer. Of these particles, silica particles and titanium oxide particles are preferred. These particles having their surface hydrophobicitizing-treated are more preferred, and hydrophobicitizing-treated silica particles are even more preferred. The amount of the external additive is not particularly limited, but is generally 0.1 to 6 parts by weight per 100 parts by weight of the toner particles.

The toner for developing the electrostatic image according to the present invention is preferably produced by a polymerization method, although the method of production is not limited, as long as it can provide a toner having the properties within the above-mentioned preferred ranges.

The followings are detailed description about the method of producing toner particles constituting the toner for developing the electrostatic image by the polymerization method.

The toner particles constituting the toner for developing an electrostatic latent image according to the present invention may be produced, for example by adding a polymerizable monomer composition containing a polymerizable monomer, a colorant, a charge control agent, a parting agent and a polymerization initiator to an aqueous dispersion medium containing an inorganic compound as a dispersion stabilizer, thereby preparing an aqueous dispersion containing droplets of the polymerizable monomer composition, and adding 0.01 to 0.5 part by weight of an anionic surfactant based on 100 parts by weight of the aforementioned polymerizable monomer to the aqueous dispersion to start a polymerization reaction.

In particular, when preparing the polymerizable monomer composition, it is preferable to first prepare a homogeneous mixture of a polymerizable monomer, a colorant, a charge control agent and a parting agent and then add a polymerization initiator thereto, from the viewpoint of control of the time for the start of the polymerization.

In the present invention, to obtain the polymerizable monomer composition, it is preferable to mix the colorant and the charge control resin to obtain a charge control resin composition, and add the charge control resin composition in advance, together with the parting agent, to the polymerizable monomer, followed by mixing these components. The amount of the colorant is generally 10 to 200 parts by weight, preferably 20 to 150 parts by weight, per 100 parts by weight of the charge control resin.

To prepare the charge control resin composition, the use of an organic solvent is preferable. By using the organic solvent, the charge control resin softens and is easily mixable with the pigment.

The amount of the organic solvent is generally 0 to 100 parts by weight, preferably 5 to 80 parts by weight, and more preferably 10 to 60 parts by weight, per 100 parts by weight of the charge control resin. Within this range, an excellent balance between dispersibility and processability of the polymerizable monomer composition is obtained. The organic solvent may be added either at one time or dividedly upon observing the condition of the mixture.

Mixing of the charge control resin and the colorant may be performed using equipment such as a roll, a kneader, a single screw extruder, a twin screw extruder, a Banbury mixer, a Buss co-kneader, and the like. When an organic solvent is used, it is preferred to use the mixing equipment in a closed system with a structure which prevents leakage of the organic solvent to the outside. Moreover, it is preferable to use the mixing equipment furnishing a torque meter, because the torque meter enables to monitor and control the dispersibility.

As a polymerizable monomer, a raw material of the binder resin, there can be mentioned, for instance, a monovinyl monomer, a cross-linkable monomer and a macromonomer. These polymerizable monomers become the binder resin component after polymerization. Specific examples of the monovinyl monomers include; aromatic vinyl monomers such as styrene, vinyltoluene, and α-methylstyrene; acrylic acid and its derivatives such as methyl acrylate, ethyl acrylate, propyl acrylate, butyl acrylate, 2-ethylhexyl acrylate, cyclohyxl acrylate, isobonyl acrylate; methacrylic acid and its derivatives such as methyl methacrylate, ethyl methacrylate, propyl methacrylate, butyl methacrylate, 2-ethylhexyl methacrylate, cyclohexyl methacrylate, isobonyl methacrylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic acid derivatives or methacrylic acid derivatives.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; divinylbenzene, divinylnaphthalene, pentaerythritol triallyl ether, and trimethylolpropane triacrylate. These crosslinkable monomers may be used alone or in a combination thereof. The amount of the crosslinkable monomer is generally 10 parts by weight or less, preferably 0.1 to 2 parts by weight, per 100 parts by weight of the monovinyl monomer.

It is preferable to use a macromonomer together with the monovinyl monomer, because this use provides a satisfactory balance between shelf stability and fixability at a low temperature. The macromonomer is an oligomer or polymer having a polymerizable carbon-carbon unsaturated double bond at its molecular chain terminal and a number average molecular weight of generally from 1,000 to 30,000.

The macromonomer is preferably the one which gives a polymer, by polymerization alone, having a glass transition temperature higher than that of a polymer obtained by polymerizing the above-mentioned monovinyl monomer alone.

The amount of the macromonomer used is generally 0.01 to 10 parts by weight, preferably 0.03 to 5 parts by weight, more preferably 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), 2,2′-azobis-(2-methyl-N-(2-hydroxyethyl))propionamide, 2,2′-azobis-(2-amidinopropane) bihydrochloride, 2,2′-azobis-(2,4-dimethyl valeronitrile), and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used.

The amount of the polymerization initiator used in the polymerization of the polymerizable monomer composition is preferably 0.1 to 20 parts by weight, more preferably 0.3 to 15 parts by weight, and most preferably 0.5 to 10 parts by weight, per 100 parts by weight of the polymerizable monomer. The polymerization initiator is added to the polymerizable monomer composition in advance.

As examples of the inorganic compounds used as a dispersion stabilizer, there can be mentioned, for instance, sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and ferric hydroxide. Of these, calcium phosphate and magnesium hydroxide which are hardly water-soluble compounds are preferred, and colloids thereof, that is, colloids of such hardly water-soluble inorganic compound are preferred.

The colloid of the hardly water-soluble inorganic compound preferably has a 50% cumulative value (D50) of the number particle diameter distribution of 0.5 μm or less, more preferably 0.4 μm or less, and preferably has a 90% cumulative value (D90) of the number particle diameter distribution of 1 μm or less, more preferably 0.9 μm or less. If particle diameter of the colloid of the hardly water-soluble inorganic compound exceeds, polymerization stability may be disturbed and the shelf stability of the toner for developing an electrostatic latent image may be deteriorated.

The dispersion stabilizer comprising a colloid of a hardly water-soluble inorganic compound is not limited by the production methods thereof. However, a colloid of a hardly water-soluble metal hydroxide obtained by increasing the pH of an aqueous solution of a water-soluble multivalent metal compound to 7 or higher, particularly a colloid of a hardly water-soluble metal hydroxide produced by reacting a water-soluble multivalent metal compound with a hydroxide of an alkali metal in an aqueous phase, is preferable.

A dispersion stabilizer comprising a colloid of a hardly water-soluble inorganic compound is particularly preferred, since it can narrow the particle diameter distribution of a polymer particles; the remaining amount of the dispersion stabilizer after washing is small; and it can sharply reproduce images.

The amount of the above-mentioned dispersion stabilizer is preferably 0.1 to 20 parts by weight based on 100 parts by weight of the polymerizable monomer. If the amount of the dispersion stabilizer is lower than 0.1 parts by weight, sufficient polymerization stability is difficult to achieve and polymerization aggregate tends to be generated. On the other hand, If the amount used exceeds 20 parts by weight, the effect of stabilizing polymerization is uneconomically saturated, and in addition, the viscosity of the aqueous dispersion medium becomes too high, making it difficult to form small droplets in the step of forming droplets of a polymerizable monomer composition.

Upon polymerization, a water-soluble polymer may be used together within the range in which environmental dependency of electrostatic properties and fixing properties of polymerized toner are not significantly changed. As the water-soluble polymer, there can be mentioned; polyvinyl alcohol, methylcellulose and gelatin.

When 0.01 to 0.5 part by weight, preferably 0.01 to 0.3 part by weight of an anionic surfactant is added based on 100 parts by weight of the polymerizable monomer upon polymerization, the toner according to the present invention can be easily obtained. Addition of anionic surfactant can narrow the particle diameter distribution of the toner particles and improve the sharpness of images. Addition of anionic surfactant can also broaden the circle degree distribution of a colloid containing particles having relatively large particle diameter within a level that does not affect the sharpness of images.

As the anionic surfactants used in the present invention, there can be mentioned; sulfonic acid and salts thereof such as dodecylbenzenesulfonic acid, sodium dodecylbenzenesulfonate, sodium aryl-alkyl-polyethersulfonate, sodium 3,3-disulfonediphenylurea-4,4-diazo-bis-amino-8-naphthol-6-sulfonate, ortho-carboxybenzene-azo-dimethylaniline and sodium 2,2,5,5-tetramethyl-triphenylmethane-4,4-diazo-bis-β-naphthol-6-sulfonate; sulfate salts such as sodium dodecyl sulfate, sodium tetradecyl sulfate, sodium pentadecyl sulfate and sodium octyl sulfate; and fatty acid and salts thereof such as sodium oleate, sodium laurate, sodium caprate, sodium caprylate, sodium caproate, potassium stearate and calcium oleate.

If the amount of the anionic surfactant is lower than 0.01 part by weight based on 100 parts by weight of the polymerizable monomer, cleaning properties may not be improved. If the amount of the anionic surfactant exceeds 0.5 part by weight, particle diameter distribution may be broadened and circle degree may become small.

Further, upon polymerization, a molecular weight modifier is preferably used. As the molecular weight modifier, there can be mentioned; mercaptans such as t-dodecyl mercaptan, n-dodecyl mercaptan, n-octyl mercaptan and 2,2,4,6,6-pentamethylheptane-4-thiol and the like. The molecular weight modifier may be added before or during polymerization reaction. The molecular weight modifier is used preferably 0.01 to 10 parts by weight, and more preferably 0.1 to 5 parts by weight, per 100 parts by weight of the polymerizable monomer used.

No limitation is imposed on a method for producing the core-shell structure toner particles, and these toner particles can be produced by a publicly known method. For example, a method such as spray-drying method, interfacial reaction method, in-situ polymerization method, or phase separation method may be named. Of these methods, the in-situ polymerization method and phase-separation method are preferable because of their efficient productivity.

The method for producing the core-shell structure toner particles using the in-situ polymerization process is described in detail below.

A polymerizable monomer to form a shell (polymerizable monomer for shell) and a polymerization initiator are added to an aqueous dispersion medium 6 including core particles dispersed therein, and the mixture is polymerized to obtain the core-shell structure toner particles. The core particles may be obtained by any of a pulverization method, a polymerization method, an association method and a phase inversion emulsification method.

As specific examples of the process for forming the shell, there can be mentioned; a process in which a polymerizable monomer for shell is added to the above-mentioned reaction system obtained the core particles; and a process in which core particles obtained in a separate reaction system are provided into the reaction system and a polymerizable monomer for shell is added and then polymerized.

The polymerizable monomer for shell may be provided into the reaction system at one time, or may be provided continuously or dividedly using a pump such as a plunger pump.

As the polymerizable monomer for shell, monomers capable of forming a polymer having a glass transition temperature of higher than 80° C. by polymerization alone, such as styrene, acrylonitrile and methyl methacrylate, may be used alone or in a combination thereof.

When the polymerizable monomer for shell is added to the reaction system, a water-soluble polymerization initiator is preferably added, because this addition makes it easy to obtain the core-shell structure toner particles. It is speculated that when the water-soluble polymerization initiator is added during addition of the polymerizable monomer for shell, the water-soluble polymerization initiator migrates to a zone surrounding the surface of the core particle, the zone where the polymerizable monomer for shell has moved, so that a polymer (shell) is easily formable on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1′-bis(hydroxymethyl)-2-hydroxyethyl)propionamide. The amount of the water-soluble polymerization initiator is generally 0.1 part to 50 parts by weight, preferably 1 to 30 parts by weight, per 100 parts by weight of the polymerizable monomer for shell.

In addition, when adding the polymerizable monomer for a shell, a surfactant such as sodium dodecylbenzenesulfonate may be added for washing so as to remove polar substances remaining near the surface of the toner particles, for example.

The temperature during polymerization is preferably 50° C. or higher, more preferably 80 to 95° C. The polymerization reaction time is preferably 1 to 20 hours, more preferably 2 to 10 hours. After completion of the polymerization, a procedure comprising filtration, washing, dehydration and drying is preferably repeated several times, as desired, in accordance with the conventional methods.

If the colloid of inorganic compound is used as the dispersion stabilizer, the colloid of a hardly water-soluble inorganic compound is preferably dissolved by adding acid so that the pH of an aqueous dispersion of toner particles to be obtained by polymerization is pH 6.5 or lower. An inorganic acid, such as sulfuric acid, hydrochloric acid or nitric acid; or an organic acid, such as formic acid or acetic acid; can be used as the acid to be added. Sulfuric acid is particularly preferable, because it has a high efficiency of its removal and its burden on production facilities is light.

There is no limitation on the method of filtering toner particles from the aqueous dispersion medium for dehydration. For example, centrifugal filtration, vacuum filtration or pressurized filtration can be named. Of these methods, centrifugal filtration is preferable.

The toner for developing an electrostatic image according to the present invention is obtained by mixing the toner particles and the external additive and, if desired, other fine particles by means of a high speed stirrer such as a Henschel mixer.

### EXAMPLES

The present invention is hereinafter to be described more specifically by the following examples. Such examples, however, are not to be construed as limiting in any way the scope of the present invention. All designations of “part” or “parts” and “%” used in the following examples mean part or parts by weight and wt. % unless expressly noted.

In the examples, the toner for developing an electrostatic image was evaluated by the following tests.

(1) Particle Diameter and Particle Diameter Distribution

The particle diameter distribution of toner particles, i.e., the ratio (Dv/Dp) of a volume average particle diameter to a number average particle diameter (Dp) was measured by means of a particle diameter measuring device (“Multisizer”, manufactured by Beckman Coulter Inc.). The measurement by the Multisizer was conducted under the following conditions:

Aperture diameter: 100 μm;

Medium: Isothone II;

Concentration: 10% and

Number of measured particles: 50,000 particles.

(2) Volume Mode Diameter, Standard Deviation and Average Circle Degree

After adding 100 μl of a 0.1% anionic surfactant aqueous solution to 20 mg of toner particles as a dispersion medium so that the particles got wet with the solution, 10 ml of water was added thereto, followed by stirring. The volume mode diameter, the average circle degree and the standard deviation were then measured by a flow type particle projection image analyzer (FPIA-2000, manufactured by Sysmex Corp.). Analysis was carried out on a volume basis (for groups of 15 μm or less).

Further, the average circle degree (C1) of toner particles having a particle dieameter of not less than (a−2b) μm to less than a μm and the average circle degree (C2) of toner particles having a particle diameter of not less than a μm to less than (a+2b) μm were also measured by the above-mentioned analyzer.

(3) A Content of Isopropyl Alcohol Extract Component

1.0 g of the toner for developing an electrostatic latent image and 100 ml of isopropyl alcohol were placed in a Soxhlet extractor in which an extraction thimble (cylindrical filter paper; No. 86R, manufactured by Toyo Roshi Ltd.) was set, and the mixture was refluxed at normal pressure for 6 hours to give an extract. The solvent was evaporated from the extract and the solid component was vacuum-dried at a temperature of 50° C. for 1 hour and weighed. This weighed value was divided by the initially weighed value of the toner for developing an electrostatic latent image, and the obtained value was multiplied by 100 to be defined as the content (%) of the isopropyl alcohol extract component.

(4) Weight Average Molecular Weight of Parting Agent

The weight average molecular weight of the parting agent (hereinafter simply referred to as weight average molecular weight or Mw) was measured by gel permeation chromatography as converted to polystyrene. Specifically, the measurement was carried out by the following procedure.

1) Preparation of Sample

The toner for developing an electrostatic latent image (about 10 mg) was dissolved in 5 ml of a tetrahydrofuran solvent, and after allowing to stand at 25° C. for 16 hours, the mixture was passed through a 0.45 μm membrane filter to give a sample.

2) Measurement Conditions

Temperature: 35° C., solvent: tetrahydrofuran, flow rate: 1.0 ml/min, concentration: 0.2 wt %, amount of sample introduced: 100 μl.

3) Column

GPC TSK gel Multipore HXL-M (30 cm ×2 columns) manufactured by Tosoh Corporation were used. The measurement was conducted under a condition that the linear correlation formula of Log (Mw)−elution time in the range of a molecular weight Mw of 1,000 to 300,000 is not less than 0.98.

(5) Amine Value of the Toner for Developing an Electrostatic Latent Image

1 g of the toner for developing an electrostatic image was dissolved in 100 ml of THF, and suction filtered through a filter paper to remove insoluble components. Then, the resulting solution was further passed through a filter with a pore size of 0.45 μm. The filtrate was titrated with a 0.01N MIBK solution of perchloric acid. Based on the amount of the perchloric acid MIBK solution required for neutralization, the amine value (mg HCl/g) of the toner for developing an electrostatic image was determined. An automatic potentiometric titration device AT-500N (manufactured by Kyoto Electronics Manufacturing Co., Ltd.) was used for titration, and #100-C172 (manufactured by same) was used as an electrode. The 0.01N MIBK perchloric acid solution used was prepared by diluting a 0.1N dioxane solution of perchloric acid (manufactured by Kishida Chemicals, for nonaqueous titration use) 10 times with MIBK. The measurement was made in a nitrogen atmosphere to avoid the influence of moisture and carbon dioxide in air.

(6) Acid Value of the Toner for Developing an Electrostatic Latent Image

The toner for developing an electrostatic image (1 g) was accurately weighed and dissolved in 100 ml of THF, and suction filtered through a filter paper to remove insoluble components. Then, the resulting filtrate was further passed through a filter with a pore size of 0.45 μm. To the filtrate, 20 ml of 0.01N methyl isobutyl ketone (MIBK) solution of tetrabutylammonium hydroxide (TBAH) was added, and then the mixture was titrated with a 0.01N MIBK solution of perchloric acid. Based on the amount of the perchloric acid solution required for neutralization, the acid value (mg KOH/g) of the toner for developing the electrostatic image was determined. The 0.01N MIBK solution of TBAH used was prepared by diluting a 30% methanol solution (manufactured by TOKYO KASEI KOGYO, for nonaqueous titration use) with MIBK. The 0.01N MIBK perchloric acid solution used was prepared by diluting a 0.1N dioxane solution of perchloric acid (manufactured by Kishida Chemicals, for nonaqueous titration use) 10 times with MIBK. The 0.01N MIBK solution of perchloric acid and the device for titration used were the same as used in test (5), and the titration procedure was performed in the same manner.

(7) Hydroxyl Value of Isopropyl Alcohol Extract Component

Solid components were obtained in the same manner as in the aforementioned evaluation in (3) 0.5 g of which was precisely weighed (W) and placed in a 200 ml beaker. Thereto was added 150 ml of a toluene/ethanol (7:3) mixed solution to dissolve the components. The solution in the beaker was titrated with a 1/10N KOH ethanol solution using a potentiometric titrator. The titrator used was AT-400 win workstation (manufactured by Kyoto Electronics Manufacturing Co., Ltd.), and automatic titration was carried out using APB-410 automatic burette. The amount of the KOH solution used in this measurement is defined as S (ml), and blank measurement is carried out at the same time, the amount of the KOH solution used in the blank measurement being defined as B (ml). Based on this, the hydroxyl value is calculated according to the following formula.
hydroxyl value=(S−B)×f×5.61/W

f: factor of KOH solution

(8) Shelf Stability

A sealable container was provided with the toner for developing an electrostatic image, closed and sealed. Then, the container was submerged in a thermostatic water chamber at a temperature of 55° C. and for 8 hours, and then the container was taken out. The toner for developing the electrostatic image was taken out from the container onto a 42-mesh sieve carefully to avoid destruction of its structure minimally. This sieve was vibrated for 30 seconds with the use of a powder measuring device (trade name: Powder Tester, manufactured by Hosokawa Micron Ltd.), with the vibration intensity of 4.5. Then, the weight of the toner remaining on the sieve was measured, and the measured value was taken as the weight of the aggregated toner. The proportion of the weight (wt. %) of the aggregated toner to the weight of the toner initially placed in the container was calculated. The measurement was made three times for one sample, and the average of the measured values was obtained and used as an index of shelf stability. The shelf stability of the toner is better as it shows a smaller value (wt. %).

(9) Fog

Recycled paper was set in a commercially available non-magnetic-one-component developing type printer (18-sheet/min machine), and a toner for developing an electrostatic image was put in a developing device of the printer. The toner for developing an electrostatic image was left standing over a day and a night under the (L/L) environment of a temperature of 10° C. and a humidity of 20%, the (N/N) environment of a temperature of 23° C. and a humidity of 50%, or (H/H) environment of a temperature of 35° C. and a humidity of 80%. Then, printing was continuously performed at a image density of 5% from the beginning, and the printing was suspended every 500 pieces of paper. The developed toner for developing an electrostatic image on the photoconductive member was stripped off and collected by sticking with an adhesive tape (trade name: Scotch Mending Tape 810-3-18, manufactured by Sumitomo 3M Limited). Then the adhesive tape was pealed to stick it on a new sheet of paper to measure “whiteness (B),” using a whiteness checker (manufactured by Nippon Denshoku Industries Co., Ltd.). At the same time, as a control, an adhesive tape alone was attached on another new sheet of paper to measure “whiteness (A)”, and the difference in whitenesses (A-B) was calculated. The maximum number of sheets of paper where the difference between the above value and the whiteness difference (A-B)(%) at initial printing (10 printing sheets) was not more than 1% was counted (counted per 500 sheets). The test printing was terminated when the number of sheets reached 10,000.

(10) Reproducibility of Fine Lines

Using the printer used in (9), the toner was left standing over a day and night under the (L/L) environment of a temperature of 10° C. and a humidity of 20%, the (N/N) environment of a temperature of 23° C. and a humidity of 50% and the (H/H) environment of a temperature of 35° C. and a humidity of 80% overnight. Line images were continuously formed at a 2×2 dotline (width: about 85 μm), and measurement was conducted every 500 sheets using printing evaluation system “RT2000” (manufactured by YA-MA Co., Ltd.) to collect data of the density distribution of the line images. At this time, all line widths with a density half the maximum density were measured as line widths, and those having a difference between the line width of the line images of the first sheet and the line width of the line images of the 500th sheet of not more than 10 μm were considered to be capable of reproducing the line images of the first sheet, and the maximum number of sheets that could maintain the difference between the line width of the line images of the first sheet and the line width of the line images of the 500th sheet of not more than 10 μm was counted. The test printing was terminated when the number of sheets reached 10,000.

(11) Blur

Recycled paper was set in the printer used in (9), and a toner for developing an electrostatic image was put in a developing device of the printer. The toner for developing an electrostatic image was left standing over a day and a night under the (N/N) environment of a temperature of 23° C. and a humidity of 50%. Then, black printing was performed at a image density of 5%, and printing state was evaluated every 500 pieces of paper to count the maximum number of sheets that could be printed without generating blur in the black solid image. The test printing was terminated when the number of sheets reached 10,000.

(12) Filming

Recycled paper was set in the printer used in (9), and a toner for developing an electrostatic image was put in a developing device of the printer. The toner for developing an electrostatic image was left standing over a day and a night under the (N/N) environment of a temperature of 23° C. and a humidity of 50%. Then, half-tone printing was performed at a image density of 5%, and printing state was evaluated every 500 pieces of paper to count the maximum number of sheets that could be printed without generating blurred white filming in the half-tone image. The test printing was terminated when the number of sheets reached 10,000.

(13) Black Streak or Black Spot

Recycled paper was set in the printer used in (9), and a toner for developing an electrostatic image was put in a developing device of the printer, and copy images were produced under the (L/L) environment of a temperature of 10° C. and a humidity of 20%. The images were evaluated every 500 pieces of paper to count the maximum number of sheets that could be printed without generating black streaks or black spots in the image. The test printing was terminated when the number of sheets reached 10,000.

### Example 1

83 parts of styrene, 17 parts of n-butylacrylate, 6 parts of carbon black (trade name “#25B”, manufactured by Mitsubishi Chemical Corporation; primary particle diameter 40 nm), 5 parts of a styrene/2-ethylhexyl acrylate/2-acryloylamino-2-methyl-1-propanesulfonic acid copolymer (trade name “FCA-1001-NS”, manufactured by Fujikura Kasei Co., Ltd., weight average molecular weight: 10,000) as a charge control resin, 0.6 part of divinylbenzene, 0.8 part of 2,2,4,6,6-pentamethylheptane-4-thiol, and 10 parts of dipentaerythritol hexamyristate (melting point: 65° C.) were dispersed in a bead mill at a room temperature to give a homogeneous mixture. To the mixture was added 5 parts of t-butyl peroxy-2-ethylhexanoate (trade name “Perbutyl O”, manufactured by NOF Corporation) as a polymerization initiator to give a polymerizable monomer composition.

At the same time, an aqueous solution containing 5.5 parts of sodium hydroxide dissolved in 50 parts of ion-exchanged water was gradually added to an aqueous solution containing 9 parts of magnesium chloride dissolved in 250 parts of ion-exchanged water, with stirring, to prepare a magnesium hydroxide colloidal dispersion. The 50% cumulative value of the number particle diameter distribution (D50) of the obtained magnesium hydroxide colloid was 0.35 μm, and the 90% cumulative value of the number particle diameter distribution (D90) was 0.84 μm. The above polymerizable monomer composition was poured into the above colloid, and the mixture was stirred at 15,000 rpm under high shearing force by means of Ebara Milder (trade name: MDN304, manufactured by EBARA Corp.), thereby forming droplets of the polymerizable monomer composition to give an aqueous dispersion containing the droplets. To the aqueous dispersion containing the droplets was added 0.05 part of dodecylbenzenesulfonic acid, and the mixture was put in a reactor equipped with a stirring blade. Stirring was conducted at a temperature of 90° C. for 4 hours to carry out a polymerization reaction to obtain an aqueous dispersion of colored polymer particles.

Separately, 2 parts of methyl methacrylate and 100 parts of water were subjected to finely-dispersing treatment using an ultrasonic emulsifier to obtain an aqueous dispersion of a polymerizable monomer for shell. The aqueous dispersion of polymerizable monomer for shell and 0.2 part of 2,2′-azobis{2-methyl-N-(2-hydroxyethyl)-propionamide (manufactured by Wako Pure Chemical Industries, Ltd., trade name: “VA-086”) were then added to the above-mentioned aqueous dispersion of colored polymer particles. Thereto was further added 1.5 parts of sodium dodecylbenzenesulfonate, and a polymerization reaction was continued for 4 hours, the reaction was stopped, to obtain an aqueous dispersion of core-shell structure toner particles having a pH of 9.5.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a toner for developing an electrostatic image. The thus obtained toner for developing the electrostatic image was evaluated in the above manner. The results are shown in Table 1.

### Comparative Example 1

A toner for developing an electrostatic latent image was prepared by conducting the same procedures as in Example 1 except that dodecylbenzenesulfonic acid and sodium dodecylbenzenesulfonate were not added. The properties of the resulting toner for developing an electrostatic latent image, the resulting image and so on were evaluated in the same manner as in Example 1. The results are shown in Table 1.

### Comparative Example 2

A four-neck flask was equipped with a reflux condenser, a water separator, a nitrogen gas inlet tube, a thermometer and a stirrer, and placed in a mantle heater. The flask was charged with a monomer composition containing 5 parts of bisphenol A-EO adduct, 5 parts of bisphenol A-PO adduct, 4 parts of terephthalic acid and 5 parts of fumaric acid, and with introducing nitrogen into the flask, a reaction was conducted by heating and stirring to give a polyester resin.

Subsequently, 70 parts of the polyester resin obtained as described above and 30 parts of carbon black (trade name “#25B”, manufactured by Mitsubishi Chemical Corporation; primary particle diameter: 40 nm) were charged into a pressure kneader and mixed. The obtained mixture was cooled and then pulverized by a feather mill to give a pigment masterbatch.

In the next place, 93 parts of the polyester resin, 10 parts of pigment masterbatch, which were obtained as described above, 2 parts of zinc salicylate metal complex (manufactured by Orient Chemical Industries, Ltd., trade name “E84”) and 2 parts of oxidized low molecular weight polypropylene (manufactured by Sanyo Chemical Industries, Ltd., trade name “Viscol TS200”) were mixed sufficiently by a Henschel mixer. The mixture was melt-kneaded by a twin-screw extrusion kneader, and the resulting kneaded product was immediately cooled and coarsely pulverized by a feather mill. The coarsely pulverized product was subjected to coarse particle classification by a jet mill (manufactured by Nippon Pneumatic Mfg. Co., Ltd., trade name “IDS”), and then fine particle classification by a DS classifier (manufactured by Nippon Pneumatic Mfg. Co., Ltd.) to give toner base particles.

To 100 parts of the obtained toner base particles were added 0.5 part of hydrophobic silica TS500 (manufactured by Cabosil Co. Ltd., BET specific surface area: 225 m²/g) and 0.3 part by weight of hydrophobic silica NAX50 (Nippon Aerosil Co., Ltd., BET specific surface area: 40 m²/g), and mixing was conducted using a Henschel mixer at a peripheral speed of 30 m/sec for 90 seconds. Subsequently, using a surface modification apparatus (Surfusing system, manufactured by Nippon Pneumatic Mfg. Co., Ltd.), surface modification of the toner base particles was carried out under conditions of highest temperature: 250° C., residence time: 0.5 second, powder dispersion density: 100 g/m³, cooling air temperature: 18° C. and cooling water temperature: 10° C. To 100 parts of toner base particles were added 0.5 part of hydrophobic silica R972 (manufactured by Nippon Aerosil Co., Ltd., BET specific surface area 110 m²/g) and 0.3 part of strontium titanate particles A1, and mixing was conducted using a Henschel mixer at a peripheral speed of 30 m/sec for 180 seconds to give a toner for developing an electrostatic latent image. The properties of the resulting toner for developing an electrostatic latent image, the resulting image and so on were evaluated in the same manner as in Example 1. The results are shown in Table 1.

### Comparative Example 3

A four-neck flask equipped with a high-speed stirrer, i.e., TK homomixer (manufactured by TOKUSHU KIKA KOGYO CO., LTD.), was charged with 650 parts of ion exchange water and 500 parts of a 0.1 mol/L Na₃PO₄ aqueous solution. The rotation number was set to 12000 rpm and the temperature was increased to 70° C. To the flask was gradually added 70 parts of a 1.0 mol/L CaCl₂ aqueous solution to prepare aqueous dispersion medium containing fine, hardly water-soluble dispersion stabilizer Ca₃(PO₄)₂

At the same time, as materials to be dispersed, 77 parts of styrene, 23 parts of 2-ethylhexyl acrylate, 0.2 part of divinylbenzene, 8 parts of carbon black, 6 parts of 1,1-bis(4-hydroxyphenyl)cyclohexane polycarbonate, 2 parts of negative charge control agent (azo dye iron compound) and 10 parts of a wax component were dispersed using an atriter (manufactured by Mitsui Mining and Smelting Co., Ltd.) for 3 hours, and thereto was then added 5 parts of 2,2′-azobis(2,4-dimethylvaleronitrile) to prepare a polymerizable monomer composition.

The polymerizable monomer composition was then introduced into the above-described aqueous dispersion medium, and the mixture was stirred at an inner temperature of 70° C. under N₂ atmosphere for 15 minutes with maintaining the rotation number of the high-speed stirrer at 12,000 rpm to form droplets of the polymerizable monomer composition. The stirrer was then replaced with a propeller stirring blade, and with stirring at 50 rpm, the system was kept at the same temperature for 10 hours to complete the polymerization. After completion of the polymerization, remaining monomers were removed under a heating and reduced pressure condition of 80° C./47 kPa (350 Torr), the suspension was cooled, and diluted hydrochloric acid was added thereto to remove the dispersion stabilizer. After repeating washing with water a few times, polymer particles were subjected to treatment for forming into spherical shape and drying for 6 hours using a conical ribbon drier (manufactured by OKAWARA MFG. CO., LTD.) with stirring by a spiral ribbon blade under a heating and reduced pressure condition of 45° C./1.3 kPa (10 Torr) for 6 hours, whereby toner particles was obtained.

100 parts of the obtained toner particles and 2 parts of oil-treated hydrophobic silica fine particles were dry-blended by a Henschel mixer to give a toner for developing an electrostatic latent image. The properties of the resulting toner for developing an electrostatic latent image, the resulting image and so on were evaluated in the same manner as in Example 1. The results are shown in Table 1.

TABLE 1

| | | Com. | Com. | Com. |
|---|---|---|---|---|
| | Ex. 1 | Ex. 1 | Ex. 2 | Ex. 3 |
| Properties of | | | | |
| toner | | | | |
| Volume average | 7.7 | 7.5 | 8.2 | 5.6 |
| particle | | | | |
| diameter | | | | |
| (μm) | | | | |
| Particle | 1.14 | 1.19 | 1.18 | 1.4 |
| diameter | | | | |
| distribution | | | | |
| (Dv/Dp) | | | | |
| Volume mode | 7.1 | 7.02 | 7.9 | 5.7 |
| diameter (μm) | | | | |
| Standard | 1.36 | 1.60 | 1.50 | 1.75 |
| deviation of | | | | |
| particle | | | | |
| diameter | | | | |
| Average circle | 0.961 | 0.971 | 0.976 | 0.984 |
| degree | | | | |
| Average circle | 0.981 | 0.981 | 0.979 | 0.988 |
| degree C1 | | | | |
| Average circle | 0.953 | 0.962 | 0.969 | 0.970 |
| degree C2 | | | | |
| C1/C2 | 1.029 | 1.020 | 1.010 | 1.019 |
| Content of | 2.8 | 5.2 | 6.3 | 7.6 |
| isopropyl | | | | |
| alcohol | | | | |
| extract | | | | |
| component (%) | | | | |
| Acid value (mg | 2.5 | 2.5 | 22.3 | 6.5 |
| KOH/g) | | | | |
| Amine value | 0.3 | 0.3 | 0.1 | 1.2 |
| (mg HCl/g) | | | | |
| Weight average | 2275 | 2275 | 1300 | 1000 |
| molecular weight | | | | |
| of parting agent | | | | |
| Hydroxyl value | 8.6 | 7.2 | 29 | 40 |
| (mg KOH/g) of | | | | |
| isopropyl | | | | |
| alcohol | | | | |
| extract | | | | |
| component | | | | |
| Image | | | | |
| properties | | | | |
| Shelf | 1.0 | 3.2 | 7.6 | 5.5 |
| stability(%) | | | | |
| Fog | | | | |
| L/L | 10,000 | 7,000 | 6,500 | 7,000 |
| N/N | 10,000 | 9,000 | 8,000 | 8,500 |
| H/H | 1,0,00 | 10,000 | 8,000 | 8,000 |
| Reproducibility | | | | |
| of fine lines | | | | |
| L/L | 10,000 | 10,000 | 7,500 | 10,000 |
| N/N | 10,000 | 10,000 | 9,000 | 10,000 |
| H/H | 9,000 | 9,000 | 9,000 | 9,000 |
| Filming | 10,000 | 8,000 | 6,500 | 8,000 |
| Blur | 10,000 | 9,000 | 8,000 | 9,000 |
| Black streak, | 10,000 | 9,000 | 8,000 | 8,500 |
| black spot | | | | |

The results of evaluation of the toners for developing an electrostatic latent image in Table 1 show the following facts:

The toners for developing an electrostatic latent image in Comparative Examples 1 to 3, in which the circle degree are larger than the ranges defined by the present invention, and the isopropyl alcohol extract component content are larger than the ranges defined by the present invention have reduced shelf stability and easily cause fog under L/L environments, N/N environments and H/H environments, and also easily suffer from filming, thinning, black streaks and black spots.

The toner for developing an electrostatic latent image of Example 1 of the present invention, on the other hand, is satisfactory in shelf stability, and is difficult to cause fog and does not suffer from filming, thinning, black streaks and black spots, which means that the toner is satisfactory in cleaning properties.

### INDUSTRIAL APPLICABILITY

According to the present invention, a toner for developing an electrostatic latent image, which is satisfactory in shelf stability, difficult to cause fog and satisfactory in cleaning properties and charging stability is provided.

1. A toner for developing an electrostatic latent image, comprising a toner particles containing at least a binder resin, a colorant, a charge control agent and a parting agent,
the toner particles having
a volume mode diameter (a) in the range from 5 to 10 μm,
the ratio (Dv/Dp), of a volume average particle diameter (Dv) to a number average particle diameter (Dp), from 1.0 to 1.3, and
an average circle degree in the range from 0.94 to 0.97,
the toner particles having a standard deviation (b) not more than 2.5 μm of particle diameter,
a ratio (C1/C2) from 1.01 to 1.03, wherein c1 represents an average circle degree of the toner particles having a particle diameter not less than (a-2b) μm to less than a μm, and c2 represents an average circle degree of the toner particles having a particle diameter not less than a μm and less than (a+2b) μm, and
the toner for developing an electrostatic latent image having a content, of an isopropyl alcohol extract component, of 5% by weight or less.

2. The toner for developing the electrostatic latent image according to claim 1, which has an acid value of 5 mg KOH/g or less.

3. The toner for developing the electrostatic latent image according to claim 1, which has an amine value of 3.25 mg HCl/g or less.

4. The toner for developing the electrostatic latent image according to claim 1, wherein the parting agent has a weight average molecular weight in the range from 1,000 to 3,000.

5. The toner for developing the electrostatic latent image according to claim 1, wherein the parting agent has a melting point in the range from 40 to 100° C.

6. The toner for developing the electrostatic latent image according to claim 1, wherein the parting agent is a synthetic wax or a multifunctional ester compound.

7. The toner for developing the electrostatic latent image according to claim 1, wherein the charge control agent is a charge control resin having a weight average molecular weight in the range from 3,000 to 300,000.

8. The toner for developing the electrostatic latent image according to claim 1, wherein the isopropyl alcohol extract component has a hydroxyl value of 25 mg KOH/g or less.

9. A process for producing a toner for developing an electrostatic latent image according to claim 1, which comprises:
adding a polymerizable monomer composition containing a polymerizable monomer, a colorant, a charge control agent, a parting agent and a polymerization initiator to an aqueous dispersion medium containing an inorganic compound as a dispersion stabilizer,
thereby preparing an aqueous dispersion containing droplets of the polymerizable monomer composition, and
adding 0.01 to 0.5 part by weight of an anionic surfactant per 100 parts by weight of the polymerizable monomer to the aqueous dispersion, subjected to initialize a polymerization reaction.

10. The process for producing the toner for developing the electrostatic latent image according to claim 9, wherein the parting agent has a weight average molecular weight in the range from 1,000 to 3,000.

11. The process for producing the toner for developing the electrostatic latent image according to claim 9, wherein the parting agent has a melting point in the range from 40 to 100° C.

12. The process for producing the toner for developing the electrostatic latent image according to claim 9, wherein the parting agent is a synthetic wax or a multifunctional ester compound.

13. The process for producing the toner for developing the electrostatic latent image according to claim 9, wherein the charge control agent is a charge control resin having a weight average molecular weight in the range from 3,000 to 300,000.

14. The process for producing the toner for developing the electrostatic latent image according to claim 9, wherein the inorganic compound is a colloid of a hardly water-soluble inorganic compound.

15. The process for producing the toner for developing the electrostatic latent image according to claim 14, wherein the colloid of a hardly water-soluble inorganic compound has a 50% cumulative value of number particle diameter distribution of 0.5 μm or less.

16. The process for producing the toner for developing the electrostatic latent image according to claim 9, wherein the inorganic compound is used in an amount of 0.01 to 20 parts by weight per 100 parts by weight of the polymerizable monomer.
